(19) United States
(12) Patent Application Publication
(10) Pub. No.: US 2013/0179276 A1
(43) Pub. Date: Jul. 11, 2013

(54) KEY TAG MAILER AND METHOD FOR DELIVERING ADVERTISEMENT INFORMATION

(71) Applicants: Scott Wheelon, Camas, WA (US); Charles Randall Townsend, Redondo Beach, CA (US)

(72) Inventors: Scott Wheelon, Camas, WA (US); Charles Randall Townsend, Redondo Beach, CA (US)

(21) Appl. No.: 13/645,294

(22) Filed: Oct. 4, 2012

Related U.S. Application Data
(60) Provisional application No. 61/584,940, filed on Jan. 10, 2012.

(51) Int. Cl. G06Q 30/02; B42D 15/00

(52) U.S. Cl. 705/14.73; 283/56

(57) ABSTRACT

The key tag mailer comprises a postcard with multiple detachable key tags deposed therein. At least some of the key tags are associated with different advertisers and some have different web address deposed thereon. In some embodiments, some of the key tags have advertising information deposed thereon, such as an advertiser name or logo. A website pointed to by the web address returns additional advertising information in response to queries using the web address. In some embodiments, the web address is encoded in a quick response (QR) code deposed on the key tag. A consumer receives key tag, scans it with a consumer device such a mobile phone, sending a query.

### CROSS-REFERENCE TO RELATED APPLICATION

This application is a non-provisional of and claims priority to co-pending U.S. Provisional Patent Application Ser. No. 61/584,940 filed 10 Jan. 2012, herein incorporated by reference.

### FIELD OF THE INVENTION

Embodiments of the present invention relate generally to the field of advertisements and, in particular, to advertisements using printed matter with machine-readable markings.

### BACKGROUND

Direct mail advertising has been practiced almost as long as there has been a mail system. A mailing, typically a postcard, is printed with advertisements, often including sales promotions that an advertiser is currently offering. Copies of the mailing are mailed to consumers. The consumers may be previous customers or potential customers for whom the advertiser has contact information. Alternatively, mailings may be sent addressed to “current resident” for addresses in an area the advertiser wants to target.

The practice of direct mail marketing is widely understood to be an expensive form of advertising when compared to other forms of advertising including digital advertising, which has recently boomed. The higher the expense of an advertising campaign, the higher the return or redemption needed to justify the expense. So direct mail marketers introduced the “shared mail” concept. “Shared mail”, or cooperative mailing, are terms for a practice in the direct mail industry where a marketing agency solicits a group of advertisers to collectively participate in the distribution of a mail-able piece of literature for the purpose of selling goods and/or services offered by each advertiser. The piece can have many different shapes and sizes, and be of different formats, including a free standing insert, a circular and the most commonly, an envelope stuffed with various sized inserts. All participating advertisers will “share” in the costs associated with the mail piece including but not limited to creative development, printing, postage and account management costs on behalf of the marketing agency. The clear advantage for shared mail or cooperative mailing is a significant cost reduction per piece mailed for each advertiser. For example, an advertiser could easily pay between $0.25-$1.00 per mail piece that featured just their product/service (also referred to as a solo mailing) versus $0.005-$0.10 per piece for shared mail.

While direct mail marketing has its advantages, there are some disadvantages. One disadvantage is that there is limited space on a mailing to include advertising information. Another disadvantage is that advertisers often want to change sales promotions, which necessitates frequent mailings. Increased frequency of mailings increases costs. Another disadvantage is that traditional direct mail promotions tend to inflexibly commit advertisers for a period of time, as promotions are often posted as valid through a date several days or weeks into the future. Advertisers would like more flexibility, to more quickly add or withdraw a promotion of a product, than is possible in a traditional direct mail system. For example, if an advertiser's supplies of the product are exhausted due to heavy sales volume or failure of suppliers to provide adequate product, the advertiser would like to be able to withdraw the promotion.

### SUMMARY AND ADVANTAGES

Embodiments related to a key tag mailer and methods for delivering advertising information with a key tag mailer are described herein. The key tag mailer is a commercial postcard product manufactured and used for the purpose of delivering advertising information from a variety of advertisers to consumers on a periodic (e.g. monthly) or aperiodic basis. The key tag mailer comprises a two-sided, polyester laminated postcard with a plurality of perforated key tags. At least some of the key tags are each associated with a different advertiser by having a different web address and/or different advertising information deposed thereon. In some embodiments, at least one web address is encoded in a quick response (QR) code. At least one of the web addresses points to a website, maintained by the business making and distributing the key tag mailer. The website when queried by the web address will return additional advertising information associated with the web address. In some embodiments, each key tag has dedicated advertising space in which to put a brief bit of advertising information, typically the advertiser's name and/or logo.

The consumer receives many benefits from the key tag mailer. The key tag is easy and convenient to remove from the mailer and attach to a key ring so the consumer can carry it on their key chain for when it's time to use it at a point of purchase. Key tags can be used multiple times for multiple offers, allowing each consumer use their mobile consumer device to quickly and easily access additional coupons, discounts and other promotional content. The promotions may be updated by the advertiser on a regular or ad hoc basis.

The advertiser also receives many benefits from the key tag mailer. Since consumers do not have to open an envelope or sort through a circular publication, each advertiser has a much higher degree of visibility and total number of consumer impressions. Convenience and ease of use has a positive effect on consumer response and redemption of discount offers. The promotional content on the website is dynamic, meaning the advertiser has the ability to update the promotional messaging as needed to help generate more consumer business. The advertiser is also able to capture, track and analyze data based on consumer behavior related to QR code usage (consumer scan activity)—very valuable for future advertising plans. Another very significant advantage that the key tag mailer has over other common forms of shared mail is the consumer doesn't have to open an envelope or a circular containing numerous pages and inserts. The key tag mailer is a single postcard that guarantees 99.9% visibility by clearly displays all participating advertisers without the need to open or turn pages.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a view of a key tag mailer in accordance with one embodiment of the invention.

FIG. 2a is a view of a front of one of the key tags of the key tag mailer of FIG. 1.

FIG. 2b is a view of a back of the same key tag as in FIG. 2a.

FIG. 3 is a view of a key tag mailer in accordance with second embodiment of the invention with a different shaped key tag.

FIG. 4 is a flow chart showing a method for delivering advertisements/promotions with a key tag mailer.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural changes may be made without departing from the scope of the present invention. Therefore, the following detailed description is not to be taken in a limiting sense, and the scope of the present invention is defined by the appended claims and their equivalents.

Reference in the specification to “one embodiment” or “an embodiment” means that a particular feature, structure, or characteristic described in connection with the embodiment is included in at least one embodiment. The appearances of the phrase “in one embodiment” in various places in the specification do not necessarily all refer to the same embodiment, but they may.

The phrase “A and/or B” means (A), (B), or (A and B). The phrase “A, B, and/or C” means (A), (B), (C), (A and B), (A and C), (B and C) or (A, B and C).

The description may use perspective-based language such as up/down, back/front, and top/bottom. Such language is merely used to facilitate the discussion and is not intended to restrict the application of embodiments of the present invention.

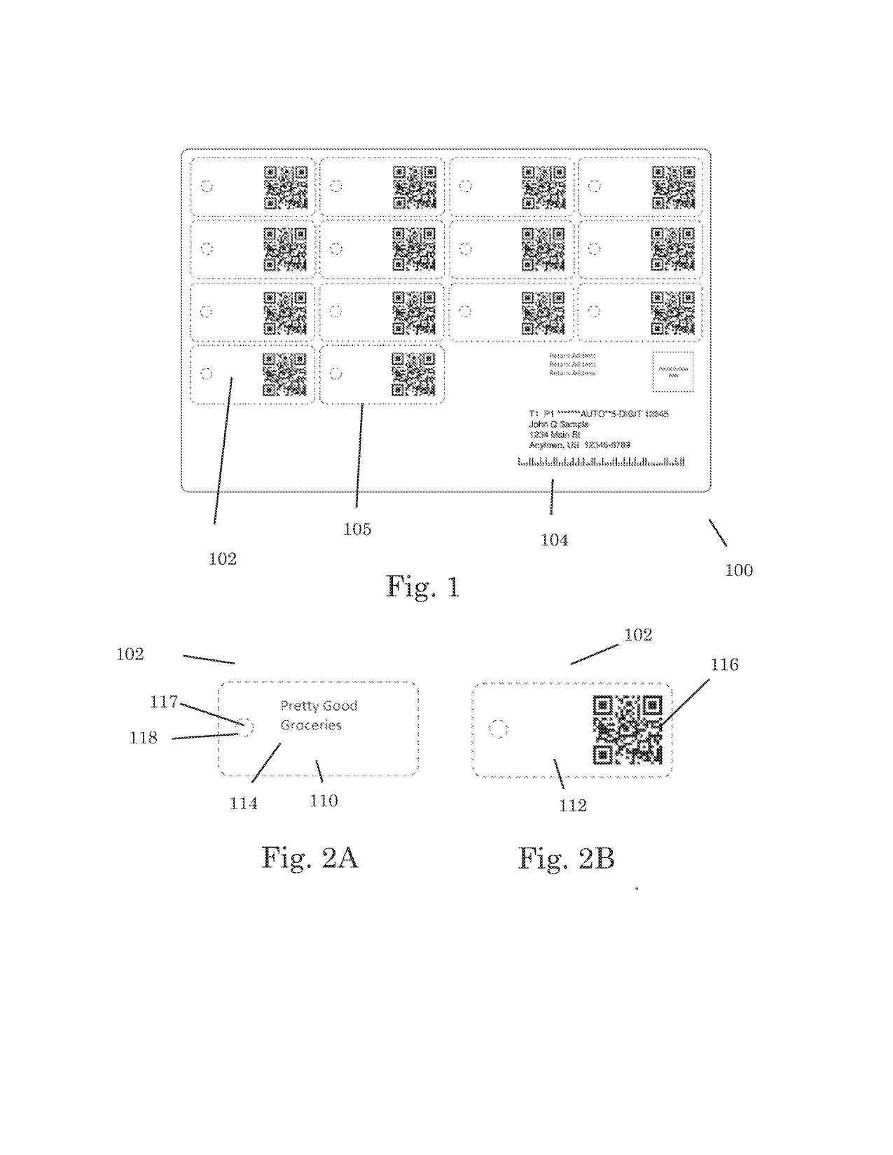

FIG. 1 is a view of a key tag mailer 100 in accordance with one embodiment of the invention. The key tag mailer 100 comprises a plurality of key tags 102. At least some of the key tags 102 are each associated with a different advertiser by having different web addresses and/or different advertising information deposed thereon.

In this embodiment, the key tag mailer 100 is made of paper stock and laminated with polyester, resulting in a thirty (30) millimeter thick laminated postcard. The thickness of the polyester laminate makes key tag mailer 100 extremely rigid and stands out from the other mail. The laminate also gives the mailer a glossy appearance—all of which can have a positive effect on consumer response and redemption levels due to high perceived value. The polyester laminate makes the key tags 102 extremely durable and will last for an extended period of time on a key ring and in harsh conditions (pocket, purse . . . etc.). In this embodiment, the key tag mailer 100 is a customized die cut postcard layout with a finish size of 8.5″×5.5″, but may be of other dimensions in other embodiments and maybe cut by different methods. In other embodiments, the key tag mailer 100 may be made of other materials, use other materials for lamination, or have no lamination and may be of different dimensions.

The key tags 102 have key tag boundaries 105 that are perforations to allow easy separation of a key tag 102 from the rest of the key tag mailer 100. The perforation of these key tags 102 is such that the key tag mailer 100, in its entirety, meets the standards of the United State Post Office, and allows for easy “punch-out” or removal by consumers. The key tag mailer 100 has an address space 104 for address and postage information.

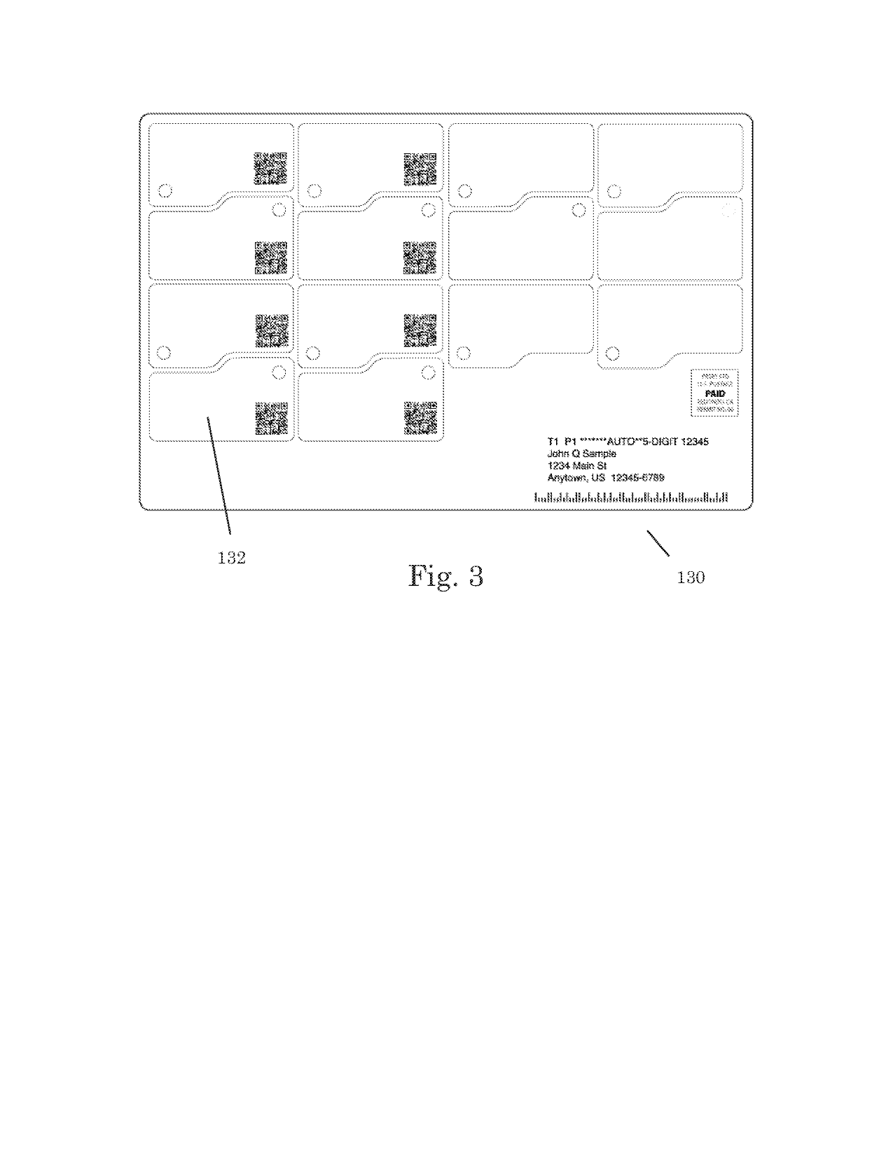

The key tag mailer 100 of this embodiment has key tags 102 sized at 1″×2″, grouped in a set of twelve (12) to fourteen (14) key tags 102. Other embodiments may have more or fewer key tags 102 per key tag mailer 100 and the key tags may be of different shape and dimensions. FIG. 3 is a view of a key tag mailer 130 in accordance with second embodiment of the invention with key tags 132 in the shape of a tabbed rectangle.

FIG. 2a shows a view of a front 110 of one of the key tags 102 and FIG. 2b shows a view of a back 112 of the same key tag 102. The key tag 102 has a key ring punch-out 117 detachably deposed in the key tag 102 by perforations. When the key ring punch-out 117 is removed, it leaves behind a key ring hole 118. The key ring hole 118 may be used to conveniently attach the key tag 102 to a key chain or key ring (not shown). In this embodiment, the key ring hole 118 is shown as deposed in the left center of the key tag 102, but in other embodiments may be deposed in a different location on the key tag.

The key tag 102 has dedicated advertising space 114 in which advertising information is printed or otherwise deposed on the key tag 102. Typically, the name of the advertiser and its logo will be printed in the dedicated advertising space 114. In this embodiment, the dedicated advertising space 114 is only on the front 110 of the key tag 102, but in other embodiments, there may be dedicated advertising space 114 on the back 112 of the key tag 102 as well.

At least some of the key tags 102 each have a unique web address printed or otherwise deposed on the key tag 102. In this embodiment, the web address is encoded in a QR (Quick Response) code 116 deposed on the key tag 102. A QR code is a type of matrix bar code or two-dimensional bar code that consists of black modules arranged in a square pattern on a white background that encodes specific data. The QR code 116 is printed on back of the key tag 102 and is easily scanned by most standard scanning devices including smart phones equipped with a scanning application that utilizes the camera of the phone to scan (decode) data encoded in the QR code 116. The web address is typically a URL (Universal Resource Locator), but may be in a different web address protocol. The web address has the purpose of obtaining or viewing promotional content related to an advertiser. At least some of the key tags 102 are each associated with different advertisers by each having a unique web address and/or advertising information such as a logo deposed thereon. This web address does not point to the advertiser's own website. Rather, the web address points to a resource (typically a web page) on a website owned by the key tag distributor.

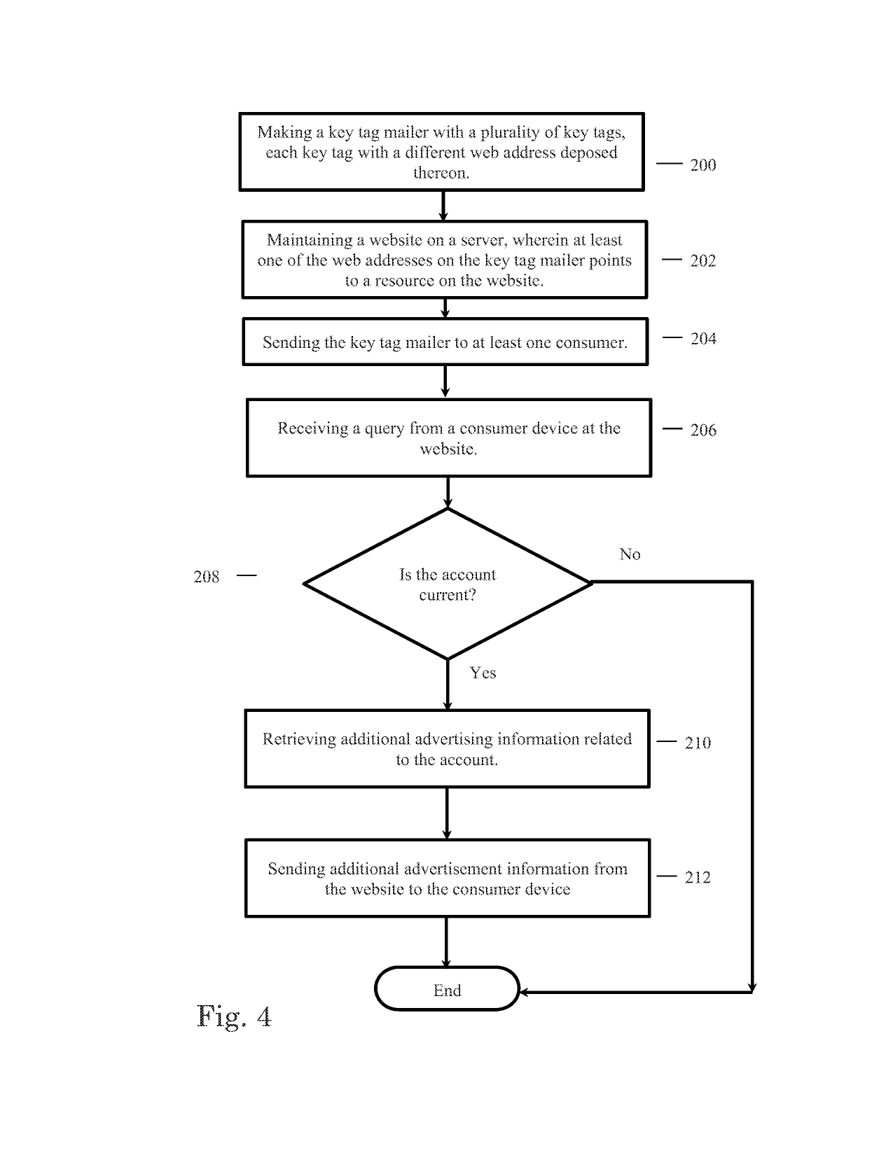

FIG. 4 is a flow chart showing a method for delivering advertisement information with a key tag mailer 100. This method is performed by an advertiser that makes and distributes key tag mailers 100, hereinafter referred to as the “key tag distributer”.

The method begins with step 200, in which the key tag distributer makes at least one key tag mailer 100 with a plurality of key tags 102 as described above in the discussion of FIGS. 1-3. In most instances, the key tag distributer makes many copies of the same key tag mailer 100.

In step 202, the key tag mailer maintains a website that is hosted on a server. The website is controlled by the key tag distributor. At least one of the web addresses on the key tag mailer 100 points at a web resource (typically a web page) on the website. This web resource is associated by the key tag distributer with an advertising account. The key tag distributer may associate the advertising account with an advertiser who has contracted with the key tag distributor to associate with one of the key tags 102 in the key tag mailer, which typically includes the right to have a brief piece of advertising information (typically the advertiser's name and logo) put on the key tag 102 and to have additional advertising information (typically current promotional information) stored on the website. The web resource is configured to store the additional advertising information associated with the advertising account and retrieve it upon query to the web address. The key tag distributor may allow the advertiser limited access to change the additional advertising information associated with the advertiser's account at the convenience of the advertiser. Typically, the web page is only one of several web pages under the control of the key tag distributor, each associated with a different advertising account and each associated with a different web address deposed on a different key tag 102.

In step 204, the key tag distributor sends the key tag mailer to at least one consumer. Typically, the key tag mailer sends out many copies of the key tag mailer, each to one of many consumers in a single batch mailing.

In step 206, the website receives a query from a consumer device, such as a mobile phone or tablet computer. This query is based on the web address, which is used to route the query to the website. Usually, the query is sent after the consumer has received the key tag in the mail and has scanned the QR code with their consumer device.

In step 208, the website checks if the advertising account associated with the web address is current. That is, the advertiser that is associated with the advertising account has paid all fees due to the key tag mailer for the mailer and web page. If the account is not current, the method ends. In some embodiments, no response is sent to the consumer device and in other embodiments, an error message is sent to the consumer device informing the consumer that the web page is not available. If the account is current, the method continues with step 210.

In step 210, the website retrieves additional advertising information.

In step 212, the website sends the additional advertising information to the consumer device. Typically, the additional advertising information is sent in a copy of a web page adapted to a format compatible with the consumer device that sent the query. This is the final step of the method, although in some embodiments, the website may have further interactions with the consumer.

Although specific embodiments have been illustrated and described herein, it will be appreciated by those of ordinary skill in the art and others, that a wide variety of alternate and/or equivalent implementations may be substituted for the specific embodiment shown and described without departing from the scope of the present invention. This application is intended to cover any adaptations or variations of the embodiment discussed herein. Therefore, it is manifested and intended that the invention be limited only by the claims and the equivalents thereof.

I claim:

1. A key tag mailer comprising:
a postcard;
a plurality of key tags detachably deposed in the postcard; and
wherein at least some of the key tags are each associated with a different advertiser.

2. The device of claim 1 wherein at least some of the key tags are each associated with a different advertiser by having different advertising information deposed thereon.

3. The device of claim 1 wherein at least some of the key tags are each associated with a different advertiser by each having a different web address deposed thereon.

4. The device of claim 3 wherein at least one of the web addresses is encoded in a Quick Response (QR) code deposed on the key tag.

5. The device of claim 3, wherein the at least one web address points to a website with additional advertising information associated with an advertiser associated with the web address.

6. The device of claim 3 wherein at least one of the web addresses is encoded in a Quick Response (QR) code deposed on the key tag, wherein the at least one web address points to a website with additional advertising information associated with an advertiser associated with the web address.

7. The device of claim 1 wherein at least one of the key tags is detachably deposed by perforations in the postcard.

8. The device of claim 1, further comprising a key ring punch-out detachably deposed in at least one of the key tags by perforations in the key tag.

9. The device of claim 1 wherein the key tag mailer is laminated.

10. A method for delivering advertisement information with key tag mailer comprising:
(a) making a key tag mailer with a plurality of key tags, each key tag with a different web address deposed thereon;
(b) maintaining a website on a server, wherein at least one of the web addresses on the key tag mailer points to a resource on the website;
(c) sending the key tag mailer to at least one consumer;
(d) receiving a query from a consumer device at the website; and
(e) sending additional advertisement information from the website to the consumer device.

11. The method of claim 10, further comprising the step of checking, before performing step (e), if an advertising account related to the web address is current, if so, then performing the step (e), if not, then ending the method without performing step (e).

12. The method of claim 11, wherein sending the additional advertisement information from the website to the consumer device further comprises sending a copy of a web page from the website to the consumer device, the web page including the additional advertisement information.

12. The method of claim 10, wherein making a key tag mailer further comprises deposing a Quick Response (QR) on at least one of the key tags, the QR code encoding the web address that key tag.

13. The method of claim 10, further comprising the step of retrieving additional advertising information related to the account.
